(19) United States
(12) Patent Application Publication
(10) Pub. No.: US 2020/0093692 A1
(43) Pub. Date: Mar. 26, 2020

(54) LIQUID TRANSFER DEVICE WITH INTEGRAL TELESCOPIC VIAL ADAPTER FOR USE WITH INFUSION LIQUID CONTAINER AND DISCRTE INJECTION VIAL

(71) Applicant: West Pharma. Services IL, Ltd., Ra'anana (IL)

(72) Inventors: Amir LEV, Kfar Saba (IL); Igor DENENBURG, Gedera (IL); Uri DAVID, Nes Ziona (IL)

(21) Appl. No.: 16/467,370

(22) PCT Filed: Nov. 30, 2017
(86) PCT No.: PCT/IL17/51308

§ 371 Date: Jun. 6, 2019

(30) Foreign Application Priority Data
Dec. 6, 2016 (IL) 249408

(51) Int. Cl. A61J 1/20; A61J 1/14; A61J 1/10

(52) U.S. Cl. CPC A61J 1/2089; A61J 1/2041; A61J 1/10; A61J 1/2058; A61J 1/1418; A61J 1/201

(57) ABSTRACT

Liquid transfer devices with an integral telescopic vial adapter for use with an infusion liquid container and an initially non-punctured intact discrete injection vial. The integral telescopic vial adapter is configured for initial telescopic snap mounting on a discrete injection vial leaving its injection vial stopper non-punctured until a subsequent compaction for puncturing the injection vial stopper. The integral telescopic vial adapter includes a safety catch mechanism for precluding advertent compaction from a pre-compacted state to a compacted state. The integral telescopic vial adapter includes a clamping arrangement for irreversibly clamping same in its final compacted state.

### FIELD OF THE INVENTION

The invention relates to medical devices in general and liquid transfer devices for use with infusion liquid containers and discrete injection vials in particular.

### BACKGROUND OF THE INVENTION

Commonly owned WIPO International Application No. PCT/IL2014/050680 entitled Liquid Transfer Devices for Use with Infusion Liquid Containers and published under WIPO International Publication No. WO 2015/019343 discloses liquid transfer devices for use with an infusion liquid container and a discrete injection vial for assisting preparation of an infusion liquid container with a medicated infusion liquid for administration to a patient. The infusion liquid containers can be in the form of an infusion bag, an infusion bottle, and the like. The infusion liquid containers contain an infusion liquid and have an intravenous (IV) or administration port. WO 2015/019343's FIG. 4 and FIG. 5 show a liquid transfer device hereinafter referred to as the WO 2015/019343 liquid transfer device, WO 2015/019343's FIG. 6 shows another liquid transfer device and WO 2015/019343's FIG. 7 shows yet another liquid transfer device.

The WO 2015/019343 liquid transfer device includes a trifurcated connector body having an IV spike for sealing insertion into an IV port, a vial adapter port with an integral vial adapter for snap fit telescopic mounting on a discrete injection vial for flow communication therewith, and a twist-off substitute IV port. The twist-off substitute IV port includes a septum which is initially sealed prior to being punctured on insertion of an IV spike of an infusion set. The bifurcated body has three lumens for the IV spike, the vial adapter port and the twist-off substitute IV port. The three lumens are in 3 way direct and continuous fluid connection such that preparation of an infusion liquid container with a medicated infusion liquid includes the following steps:

Step 1 snap fit telescopic mounting a liquid transfer device's vial adapter onto a discrete injection vial.

Step 2 inserting the liquid transfer device's IV spike into an infusion liquid container's IV port for establishing an immediate flow path between the infusion liquid container and the discrete injection vial.

Step 3 repeated forward and backward transfer of liquid contents from the infusion liquid container to the discrete injection vial to mix or reconstitute the injection vial's medicament to form medicated infusion liquid in the infusion liquid container.

Step 4 opening the liquid transfer device's substitute IV port and inserting an infusion set's IV spike thereinto for establishing immediate flow path between the infusion liquid container and the infusion set ready for gravitational flow of medicated infusion liquid from the infusion liquid container to a patient.

In some medical institutions, Step 1 to Step 4 are performed in quick succession adjacent a patient immediately before administration notwithstanding a healthcare provider having gloved hands has to be dexterous to handle a liquid transfer device and a discrete injection vial. In other medical institutions, such bedside preparation is regarded as inconvenient and problematic and prefer Step 1 to Step 3 be performed beforehand and only Step 4 be performed adjacent a patient immediately before administration. But such early preparation of a medicated infusion liquid inherently leads to a delay between preparation and administration with a possible detrimental effect to a medicated infusion liquid.

There is a need to facilitate administration of medicated infusion liquids.

### SUMMARY OF THE INVENTION

The present invention is directed towards liquid transfer devices similar to the aforementioned WO 2015/019343 liquid transfer device. The liquid transfer devices of the present invention differ from the former as follows: First, the liquid transfer devices include an integral telescopic vial adapter for snap fit telescopic mounting on a discrete injection vial but leaving it intact insofar as its injection vial stopper remains non-punctured until a subsequent compaction. Second, the integral telescopic vial adapter includes a safety catch mechanism for precluding its advertent compaction from a pre-compacted state to a compacted state. The safety catch mechanism requires a user release action to release same. User release actions can include inter alia a twist action, a pull action, removal of a safety catch, and the like. And third, the integral telescopic vial adapter includes a clamping arrangement for irreversibly clamping same in its compacted state. The liquid transfer devices of the present invention are not limited to a twist-off substitute IV port but can be equally fitted with, for example, a substitute IV port requiring the breaking of a frangible component for opening the substitute IV port for insertion of an infusion set's IV spike thereinto.

The liquid transfer devices preferably enable a non-punctured intact discrete injection vial to be readily detached from an integral telescopic vial adapter after snap fit telescopic mounting before user compaction for puncturing its injection vial stopper. Such detachment can prevent wastage of injection vials which might otherwise occur in case of early preparation of a medicated infusion liquid and a subsequent decision that the medicated infusion liquid is no longer required to be administered to a patient. Such detachment is preferably achieved by a pincers-like compression. The pincers-like compression is effected by an intact discrete injection vial release tool having an opposite pair of inward directed protrusions. The intact discrete injection vial release tool can be configured as a pincers-like hand tool or a user-operated electromechanical apparatus. The use of an intact discrete injection vial release tool to detach non-punctured intact discrete injection vials as opposed to manual detachment enables only authorized healthcare providers to detach same.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of a conventional administration set including an infusion bag, the WO 2015/019343 liquid transfer device, a discrete injection vial, and an infusion set;

FIG. 1A is a longitudinal cross section of the discrete injection vial along a cross section line 1A-1A in FIG. 1;

FIG. 2A is a top plan view of the WO 2015/019343 liquid transfer device;

FIG. 2B is a longitudinal cross section of the WO 2015/019343 liquid transfer device along a cross section line 2B-2B in FIG. 2A;

FIG. 3 is a front perspective view of a liquid transfer device including an integral telescopic vial adapter having a twist release safety catch mechanism in a pre-compacted state for mounting on a discrete injection vial and a pincers-like hand tool for releasing a non-punctured intact discrete injection vial from the liquid transfer device;

FIG. 4 is a front elevation view of the FIG. 3 liquid transfer device;

FIG. 5 is a right elevation side view of the FIG. 3 liquid transfer device;

FIG. 6 is a left elevation side view of the FIG. 3 liquid transfer device;

FIG. 7 is an exploded perspective view of the FIG. 3 vial adapter;

FIG. 8 is a longitudinal cross section of the FIG. 3 liquid transfer device along a cross section line 8-8 in FIG. 3;

FIG. 9 is a front elevation view of the FIG. 3 liquid transfer device in an initial pre-compacted state mounted on the discrete injection vial;

FIG. 10 is a longitudinal cross section of the FIG. 3 liquid transfer device mounted on the discrete injection vial along a cross section line 10-10 in FIG. 9;

FIG. 11 is a left elevation side view showing the use of the pincers-like hand tool in the pre-compacted state for releasing the non-punctured intact discrete injection vial from the FIG. 3 liquid transfer device;

FIG. 12 is a longitudinal cross section of the FIG. 3 liquid transfer device along a cross section line 12-12 in FIG. 11;

FIG. 13 is a front elevation view of the FIG. 3 liquid transfer device in an intermediate primed state mounted on the discrete injection vial;

FIG. 14 is a longitudinal cross section of the FIG. 3 liquid transfer device mounted on the discrete injection vial along a cross section line 14-14 in FIG. 13;

FIG. 15 is a front elevation view of the FIG. 3 liquid transfer device in a compacted state mounted on the discrete injection vial for flow communication therewith;

FIG. 16 is a longitudinal cross section of the FIG. 3 liquid transfer device mounted on the discrete injection vial along a cross section line 16-16 in FIG. 15;

FIG. 17 is a front perspective view of a liquid transfer device having a pull release safety catch mechanism in a pre-compacted state;

FIG. 18 is a longitudinal cross section of the FIG. 17 liquid transfer device in an intermediate primed state;

FIG. 19 is a longitudinal cross section of the FIG. 17 liquid transfer device in a compacted state;

FIG. 20 is a front perspective view of a liquid transfer device having a safety catch mechanism with a safety catch in a pre-compacted state; and

FIG. 21 is a front perspective view of the FIG. 20 liquid transfer device in a compacted state after removal of its safety catch.

### DETAILED DESCRIPTION OF PREFERRED EMBODIMENT OF THE INVENTION

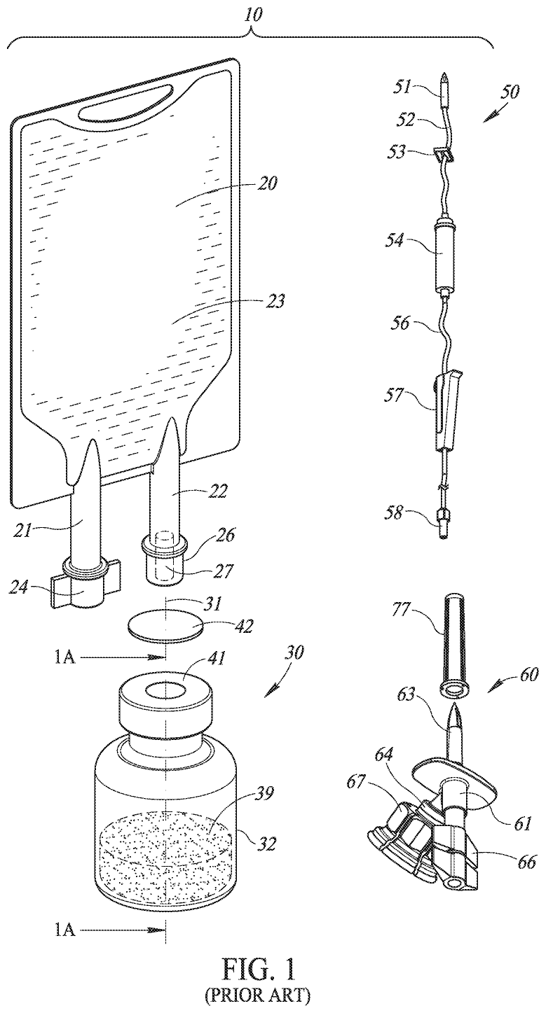

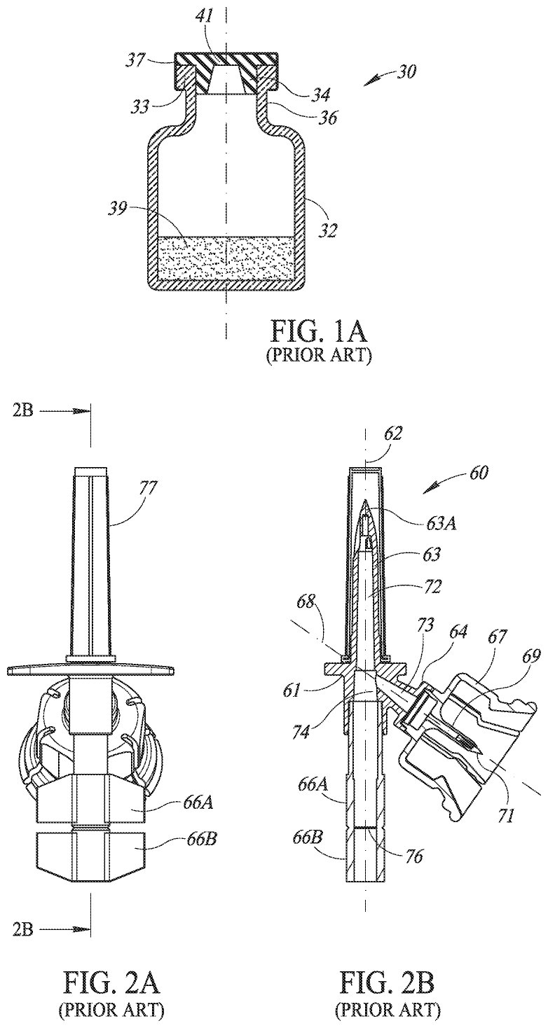

FIG. 1 shows an administration set 10 including an infusion liquid container 20, an initially non-punctured intact discrete injection vial 30, an infusion set 50, and a WO 2015/019343 liquid transfer device 60. The infusion liquid container 20 is constituted by an intravenous (IV) bag having an IV or administration port 21 and an injection port 22 and containing an infusion liquid 23. The IV port 21 is sealed by a twist-off cap 24 for insertion of an IV spike for administration purposes. The injection port 22 terminates in an injection port tip 26 with a seal-sealing plug 27 intended for needle insertion of syringe contents into the IV bag 20.

FIG. 1A shows the discrete injection vial 30 has a longitudinal injection vial centerline 31 and includes a closed end vial tube 32, a tubular vial crown 33 having a crown opening 34 and a vial neck 36 intermediate the vial tube 32 and the vial crown 33. The injection vial 30 includes an injection vial stopper 37 for hermetically sealing the crown opening 34. The vial crown 33 is capped by a band 38. The injection vial 30 contains a medicament 39 for introduction into the infusion liquid 23 to form a medicated infusion liquid. The medicament 39 can be in solid form, powder form or liquid form. The injection vial 30 has an uppermost injection vial surface 41 which is sterilized before accessing the injection vial 30 for forming a medicated infusion liquid. The injection vial 30 includes a flip-off tamper evidence cap 42 which is irreplaceably removed immediately before use to expose the uppermost injection vial surface 41. The tamper evidence cap 42 is intended to be single use such that it cannot be replaced after removal.

The infusion set 50 includes an IV spike 51 and additionally includes first tubing 52, a clamp 53, a drip chamber 54, second tubing 56, a roller clamp 57, and a male Luer connector 58.

FIG. 1, FIG. 2A and FIG. 2B show the WO 2015/019343 liquid transfer device 60 includes a trifurcated Y-shaped connector body 61 having a longitudinal connector body centerline 62, an IV spike 63 for sealing insertion into the IV port 21, a vial adapter port 64, and a twist-off substitute IV port 66. The IV spike 63 has an IV spike tip 63A. The vial adapter port 64 has an integral vial adapter 67 with a vial adapter centerline 68 intercepting the longitudinal connector body centerline 62. The vial adapter 67 has a puncturing cannula 69 with a puncturing cannula tip 71. The connector body 61 has a lumen 72 terminating at the IV spike 63, a lumen 73 in flow communication with the puncturing cannula 69 and a lumen 74 terminating at the substitute IV port 66. The three lumens 72, 73 and 74 are in three way direct and continuous fluid connection. The substitute IV port 66 is formed from suitable flexible plastic material, for example, PVC, and the like, for sealing receiving the IV spike 51. The substitute IV port 66 includes a septum 76 intended to be punctured on insertion of the IV spike 51. The substitute IV port 66 includes a proximal section 66A and a distal section 66B. In use, the distal section 66B is twisted and broken off from the proximal section 66A thereby exposing the septum 76 for puncturing by the infusion set's IV spike 51. The liquid transfer device 60 can include an IV spike cover 77 to protect the IV spike 63.

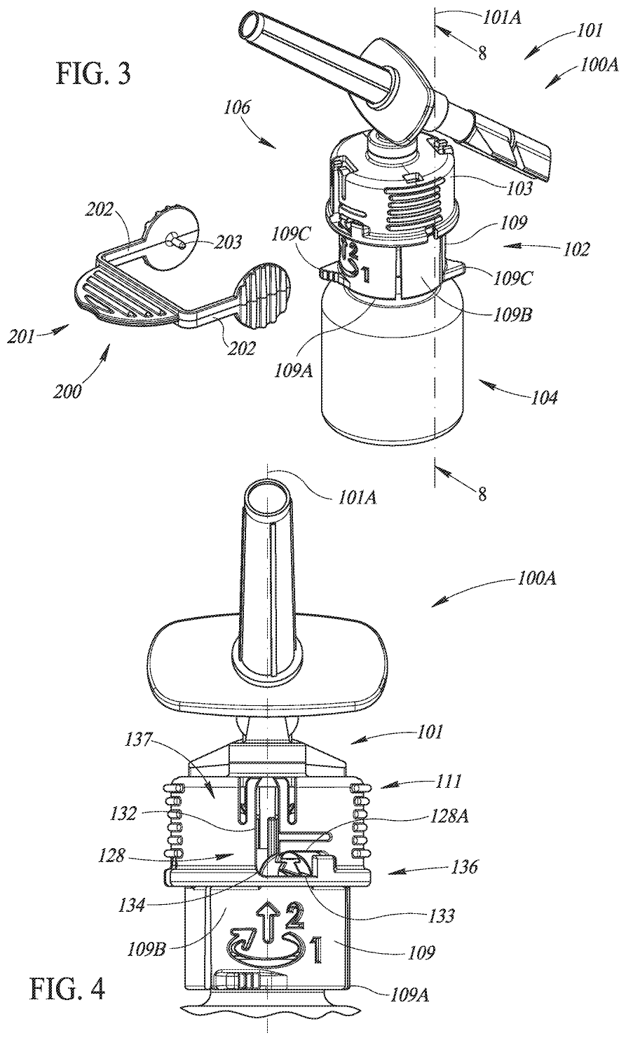

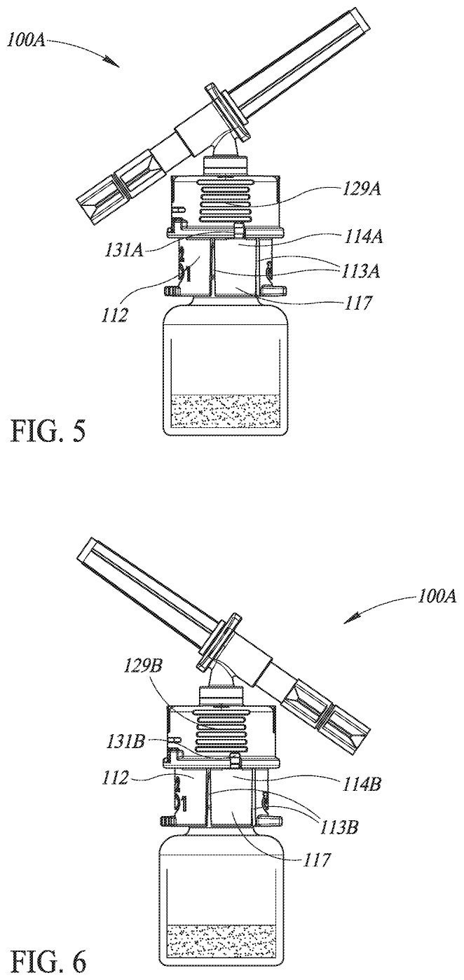

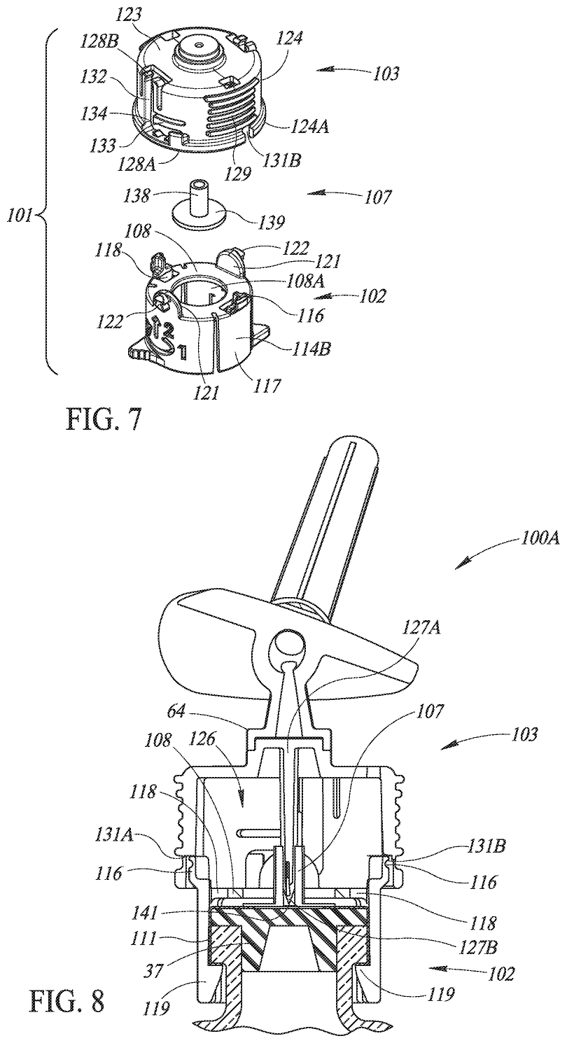

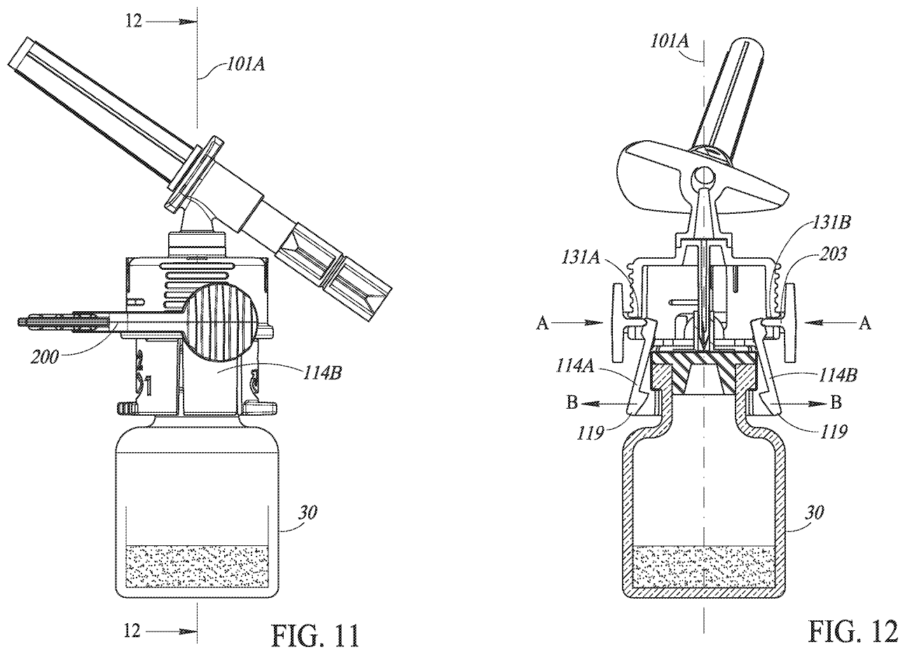

FIG. 3 to FIG. 16 show a liquid transfer device 100A having a similar construction and operation as the WO 2015/109343 liquid transfer device 60. FIG. 3 also shows a pincers-like hand tool 200 for releasing a non-punctured intact discrete injection vial 30. The pincers-like hand tool 200 includes a pincers-like body 201 with an opposite pair of jaws 202 each terminating at an inward directed protrusion 203. The opposite pair of jaws 202 can be readily manually urged towards one another for applying a pincers-like compression for releasing a non-punctured intact discrete injection vial 30 as described hereinbelow with reference to FIG. 11 and FIG. 12.

The liquid transfer device 100A differs from the liquid transfer device 60 insofar that it includes an integral telescopic vial adapter 101 with a longitudinal vial adapter centerline 101A and having two part construction: an inner vial adapter body 102 and an outer vial adapter body 103. The integral telescopic vial adapter 101 includes a twist release safety catch mechanism 104 for preventing inadvertent user compaction from a pre-compacted state to a compacted state and a clamping arrangement 106 for irreversibly clamping the integral telescopic vial adapter 101 in its compacted state. The integral telescopic vial adapter 101 additionally includes an inverted T-shaped sealing member 107.

The inner vial adapter body 102 has an inverted cup shape including an uppermost transverse annular inner vial adapter body wall 108 and a downward depending vial crown sleeve 109 with a lowermost vial crown sleeve rim 109A. The inner vial adapter body 102 bounds a vial crown cavity 111 for snugly receiving the vial crown 33 therein on telescopically snap fitting the inner vial adapter body 102 thereon. The uppermost transverse annular inner vial adapter body wall 108 has a center uppermost transverse annular inner vial adapter body wall throughgoing aperture 108A along the longitudinal vial adapter centerline 101A overlying the uppermost injection vial surface 41 on telescopically snap fitting on the discrete injection vial 30.

The vial crown sleeve 109 includes a major vial crown sleeve surround 112 with a first adjacent pair of longitudinal directed slits 113A and a second adjacent pair of longitudinal directed slits 113B for correspondingly forming a diametric pair of vial crown holding members 114A and 114B. The diametric pair of vial crown holding members 114 are pivotal with respect to the major vial crown sleeve surround 112 such that each vial crown holding member 114 has a proximal vial crown holding member section 116 and a distal vial crown holding member section 117. The uppermost transverse annular inner vial adapter body wall 108 preferably has a diametric pair of cutouts 118 inward of the diametric pair of vial crown holding members 114 such that the diametric pair of vial crown holding members 114 pivot on the uppermost transverse annular inner vial adapter wall 108.

The distal vial crown holding member sections 117 are each provided with a radial inward vial crown holding projection 119 towards the lowermost vial crown sleeve rim 109A for snap fitting under the vial crown 33 on telescopically snap fitting the inner vial adapter body 102 on the initially non-punctured intact discrete injection vial 30. Application of a pincers-like compression on the proximal vial crown holding member sections 116 towards the longitudinal vial adapter centerline 101A pivots the vial crown holding members 114A and 114B with respect to the major vial crown sleeve surround 112 thereby distancing the radial inward vial crown holding protrusions 117 from the longitudinal vial adapter centerline 101A.

The uppermost transverse annular inner vial adapter body wall 108 has a diametric pair of upright wings 121A and 121B orthogonal to the diametric pair of vial crown holding members 114A and 114B. The diametric pair of upright wings 121 each have a radial outward projection 122 constituting a component of both the twist release safety catch mechanism 104 and the clamping arrangement 106. The vial crown sleeve 109 has a peripheral vial crown sleeve surface 109B with a diametric pair of user indications for indicating a first user step denoted by a circular arrow labelled 1 and a second user step denoted by an upright arrow labelled 2 for activating the liquid transfer device 100A. The vial crown sleeve 109 has a diametric pair of radial outward finger grips 109C towards the lowermost downward depending vial crown sleeve rim 109A.

The outer vial adapter body 103 has an inverted cup shape including an uppermost transverse outer vial adapter body wall 123 and a downward depending skirt 124 with a lowermost skirt rim 124A. The uppermost transverse outer vial adapter body wall 123 is integral mounted on the vial adapter port 64. The outer vial adapter body 103 bounds an inner vial adapter body cavity 126 for snugly telescopically receiving the inner vial adapter body 102 therein on compacting the integral telescopic vial adapter 101 from a pre-compacted state to a compacted state.

The uppermost transverse outer vial adapter body wall 123 includes a downward depending puncturing cannula 127 with a proximal puncturing cannula opening 127A and a distal puncturing cannula tip 127B. The proximal puncturing cannula opening 127A is in flow communication with the vial adapter port 64 and the distal puncturing cannula tip 127B punctures the injection vial stopper 37 in the compacted state of the liquid transfer device 100A.

The downward depending skirt 124 has a diametric pair of L-shaped tracks 128 co-directional with the longitudinal vial adapter centerline 101A constituting a component of both the twist release safety release mechanism 104 and the clamping arrangement 106. The downward depending skirt 124 includes a diametric pair of anti-slip surfaces 129 generally orthogonal to the diametric pair of L-shaped tracks 128 and the diametric pair of radial outward finger grips 109C in the initial pre-compacted state of the liquid transfer device 101A. The downward depending skirt 124 also has a diametric pair of throughgoing discrete injection vial release apertures 131 for use during the release of the discrete injection vial 30. The discrete injection vial release apertures 131 are disposed beneath the anti-slip surfaces 129 and designed to require the pincers-like hand tool 200 to apply a pincers-like compression for releasing a non-punctured intact injection vial 30 and preclude manual application of the pincers-like compression.

Each L-shaped track 128 includes a major track leg 132 co-directional with the longitudinal vial adapter centerline 101A, a minor track leg 133 transverse to the longitudinal vial adapter centerline 101A and a juncture 134 between its major leg 132 and its minor leg 133. Each L-shaped track 128 has a start track end 128A adjacent the lowermost skirt rim 124A and a finish track end 128B adjacent the uppermost transverse outer vial adapter body wall 123. Each minor track leg 133 has a one-way passage arrangement 136 for irreversibly enabling priming of the liquid transfer device 100A. Each finish track end 128B has a one-way passage arrangement 137 constituting a component of the clamping arrangement 106.

The sealing member 107 has a sealing member tube 138 for mounting on the puncturing cannula 127 and a flat sealing member base 139 disposed in the central uppermost transverse annular inner vial adapter body wall throughgoing aperture 108A in the initial pre-compacted state of the liquid transfer device 100A. The central part of the flat sealing member base 139 acts as a sealing member septum 141 for maintaining sterility of the distal puncturing cannula tip 127B. The flat sealing member base 139 is sealing disposed on the uppermost injection vial surface 41 on telescopic mounting the liquid transfer device 100A on the injection vial 30. The sealing member septum 141 is intended to be punctured by the distal puncturing cannula tip 127B in the compacted state of the liquid transfer device 100A.

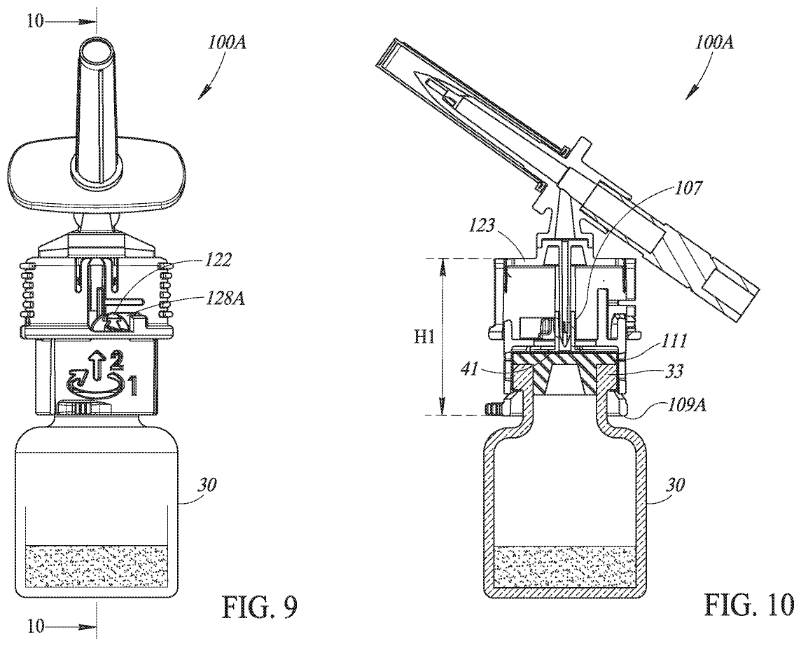

The use of the liquid transfer device 100A is now described with reference to FIG. 9 to FIG. 16.

FIG. 9 and FIG. 10 show the liquid transfer device 100A in an initial pre-compacted state mounted on the discrete injection vial 30. The vial crown cavity 111 snugly receives the vial crown 33. The radial outward projections 122 are disposed at the start track ends 128A. The sealing member base 139 is sealingly disposed on the uppermost injection vial surface 41 after removal of the tamper evidence cap 42. The proximal vial crown holding member sections 116 are disposed at the discrete injection vial release apertures 131. The integral telescopic vial adapter 101 has a pre-compacted height H1 between the uppermost transverse outer vial adapter body wall 123 and the lowermost vial crown sleeve rim 109A.

In the event it is decided not to administer the medicament and re-use the non-punctured intact discrete injection vial 30, a healthcare provider takes the following steps as shown in FIG. 11 and FIG. 12: the healthcare provider aligns the pincers-like hand tool 200 with the integral telescopic vial adapter 101 for inserting the opposite pair of inward directed protrusions 203 through the diametric pair of discrete injection vial release apertures 131. The healthcare provider applies a pincers-like compression on the proximal vial crown holding member sections 116 for urging them towards the longitudinal vial adapter centerline 101A as denoted by arrows A. The diametric pair of vial crown holding members 114 pivot with respect to the major vial crown sleeve surround 112 thereby distancing the diametric pair of radial inward vial crown holding projections 119 away from the longitudinal vial adapter centerline 101A as denoted by arrows B to release the non-punctured intact discrete injection vial 30. The healthcare provider withdraws the non-punctured intact discrete injection vial 30 from the inner vial adapter body 102 as denoted by arrow C for subsequent use and discards the liquid transfer device 100A. The discrete injection vial 30 is still regarded as being intact notwithstanding that its flip-off tamper evidence cap 42 has been removed and isn't replaceable. The discrete injection vial 30 is intact in the sense that its injection vial stopper 37 has not been punctured therethrough for establishing flow communication with its vial tube 32.

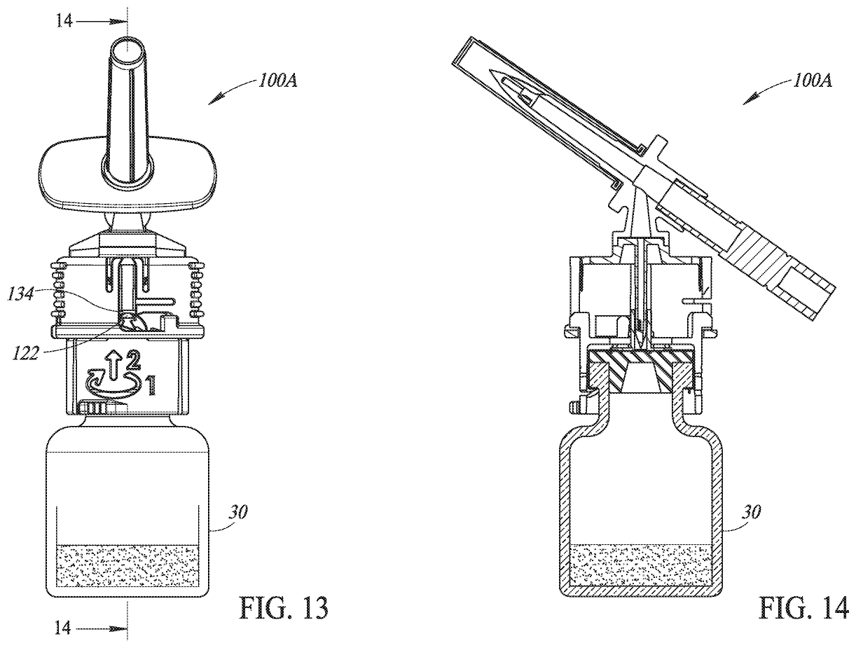

FIG. 13 and FIG. 14 show the liquid transfer device 100A after a healthcare provider has held the diametric pair of anti-slip surfaces 129 in one hand and the applied a rotation force to the diametric pair of radial outward finger grips 109C to rotate the inner vial adapter body 102 relative to the outer vial adapter body 103 about the longitudinal vial adapter centerline 101A to an intermediate primed state. The radial outward projections 122 travel along the minor track legs 133 until they reach their respective junctures 134. The one-way passage arrangements 136 prevent returning the liquid transfer device 100A to its initial pre-compacted state from the intermediate primed state thereby precluding releasing the discrete injection vial 30. The proximal vial crown holding member sections 116 are rotated away from the discrete injection vial release apertures 131 thereby precluding use of the pincers-like hand tool 200 to release the intact discrete injection vial 30 from the liquid transfer device 100A.

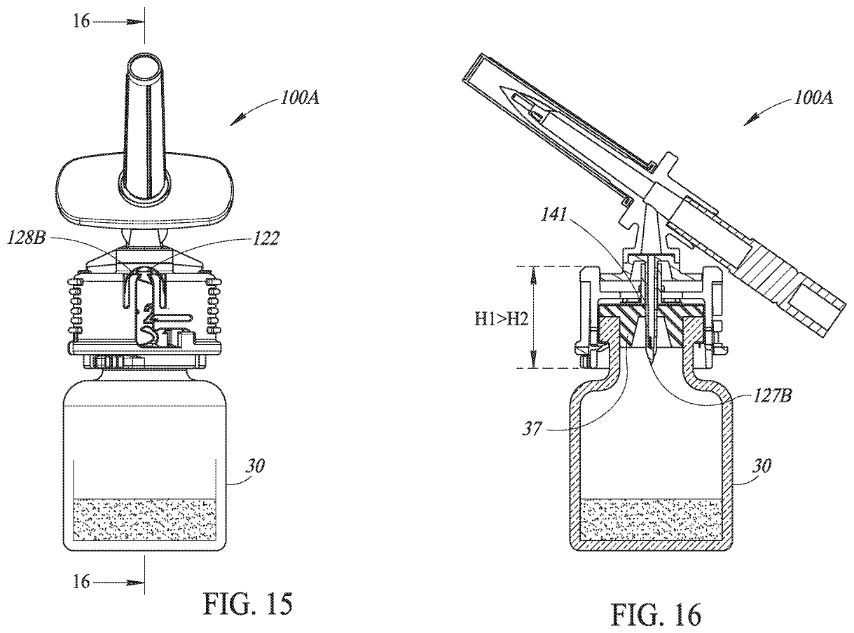

FIG. 15 and FIG. 16 show the liquid transfer device 100A in a final compacted state on telescopic mounting the outer vial adapter body 103 onto the inner vial adapter body 102 such that the outer vial adapter body 103 snugly receives the inner vial adapter body 102 therein. The radial outward projections 122 travel along the major track legs 132 until they pass through the one-way passage arrangements 137 at the finish track ends 128B thereby irreversible clamping the integral telescopic vial adapter 101 in its compacted state. The distal puncturing cannula tip 127B punctures the sealing member septum 141 and thereafter the injection vial stopper 37 for establishing flow communication between the puncturing cannula 127 and the vial tube 32 for preparing a medicated infusion liquid. The integral telescopic vial adapter 101 has a compacted height H2 between the uppermost transverse outer vial adapter body wall 123 and the lowermost vial crown sleeve rim 109A where H1>H2.

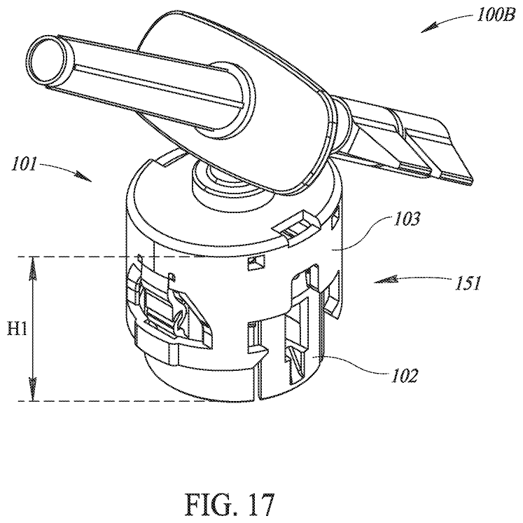

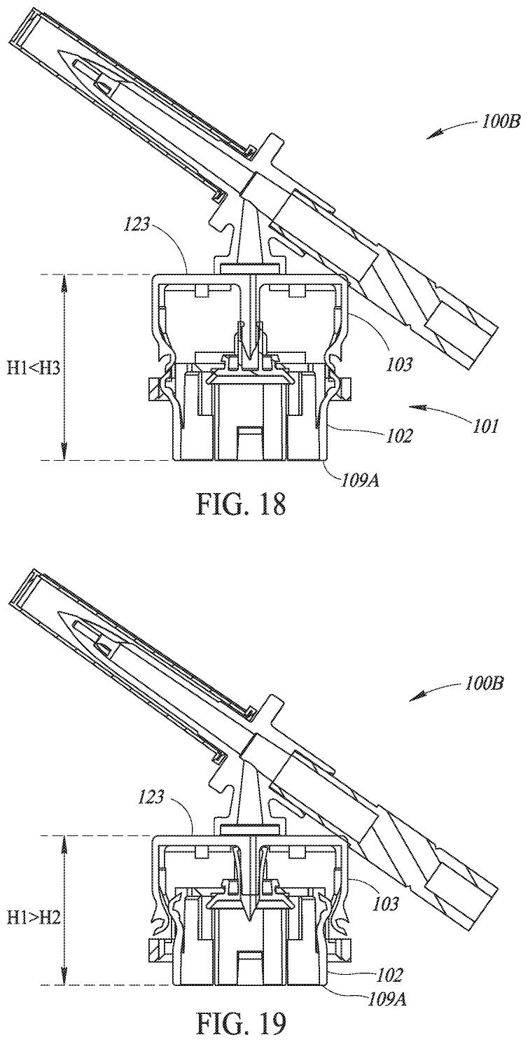

FIG. 17 to FIG. 19 show a liquid transfer device 100B having a similar construction as the liquid transfer device 100A and therefore similar parts are likewise numbered. The latter 100B differs from the former 100A insofar as the latter 100B includes a pull release safety catch mechanism 151 as opposed to the twist release safety catch mechanism 104. FIG. 17 shows the liquid transfer device 100B in its pre-compacted state having a pre-compacted height H1. FIG. 18 shows the liquid transfer device 100B in its intermediate primed state having a primed vial adapter height H3 between the uppermost transverse outer vial adapter body wall 123 and the lowermost vial crown sleeve rim 109A where H3>H1 after an initial extension of the inner vial adapter body 102 from the outer vial adapter body 103 co-directional with the longitudinal vial adapter centerline 101A. FIG. 19 shows the liquid transfer device 100B in its compacted state having a compacted height H2 where H1>H2 after the outer vial adapter body 103 snugly telescopically receives the inner vial adapter body 102 therein.

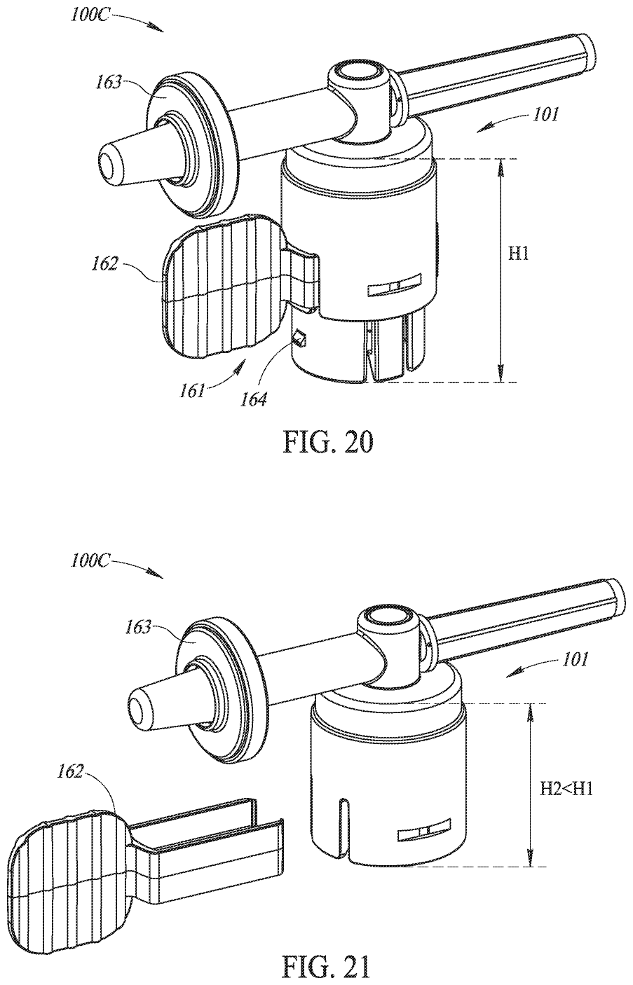

FIG. 20 and FIG. 21 show a liquid transfer device 100C having a similar construction as the liquid transfer device 100A and therefore similar parts are likewise numbered. The latter 100C differs from the former 100A in several respects as follows: The latter 100C includes a safety catch mechanism 161 having a safety catch 162 as opposed to the twist release safety catch mechanism 104. The latter 100C includes a substitute IV port having a frangible member 163 which is broken off for enabling insertion of the IV spike 51 thereinto. The latter 100C includes a diametric pair of clamping members 164 constituting a component of a clamping arrangement for irreversible clamping the integral telescopic vial adapter 101 in a final compacted state.

FIG. 20 shows the safety catch 162 extending transversely through the outer vial adapter body 103 preventing manual compaction of the liquid transfer device 100C from its pre-compacted state to its compacted state. The integral telescopic vial adapter 101 has a pre-compacted height H1. FIG. 21 shows the liquid transfer device 100C in its compacted state after removal of the safety catch 162 from the outer vial adapter body 103 thereby enabling the outer vial adapter body 103 to snugly telescopically receive the inner vial adapter body 102 therein. The integral telescopic vial adapter 101 has a compacted height H2 where H1>H2.

While particular embodiments of the present invention are illustrated and described, it would be obvious to those skilled in the art that various other changes and modifications can be made without departing from the spirit and scope of the invention.

1-10. (canceled)

11. A liquid transfer device for use with an infusion liquid container containing an infusion liquid and having an intravenous (IV) port for administering the infusion liquid, an initially non-punctured intact discrete injection vial having a closed end vial tube containing a medicament, a tubular vial crown with a crown opening stopped by a non-punctured injection vial stopper, and an uppermost injection vial surface, and an infusion set including an IV spike for sealing insertion into an IV port and a connector for administration purposes to a patient,
the liquid transfer device comprising a trifurcated connector body having an IV spike for sealing insertion into the infusion liquid container's IV port, a vial adapter port with an integral telescopic vial adapter for telescopic snap fit mounting on the discrete injection vial, and a substitute IV port for sealingly receiving the infusion set's IV spike,
said IV spike, said vial adapter port and said substitute IV port being in 3 way direct and continuous fluid communication thereby enabling an initial forming of a medicated infusion liquid in the infusion liquid container and a subsequent administration of the mediated infusion liquid to a patient,
said integral telescopic vial adapter having a longitudinal vial adapter centerline and comprising:
i) an inner vial adapter body having an inverted cup shape with an uppermost transverse annular inner vial adapter body wall and a downward depending vial crown sleeve with a lowermost vial crown sleeve rim,
said inner vial adapter body bounding a vial crown cavity for snugly receiving the vial crown on telescopic mounting said inner vial adapter body thereon,
ii) an outer vial adapter body having an inverted cup shape with an uppermost transverse outer vial adapter body wall and a downward depending skirt,
said outer vial adapter body bounding an inner vial adapter body cavity for snugly telescopically receiving said inner vial adapter body therein on compacting said integral telescopic vial adapter from an initial pre-compacted state having a pre-compacted height H1 to a final compacted state having a compacted height H2 where H1>H2, wherein said pre-compacted height H1 and said compacted height H2 are between said uppermost transverse outer vial adapter body wall and said lowermost vial crown sleeve rim,
a downward puncturing cannula with a proximal puncturing cannula opening in flow communication with said vial adapter port and a distal puncturing cannula tip for puncturing the injection vial stopper for flow communication with the vial tube,
iii) a safety catch mechanism for preventing inadvertent user compaction of said vial adapter from said pre-compacted state to said compacted state, and
iv) a clamping arrangement for irreversibly clamping said vial adapter in said final compacted state,
said vial adapter being configured such that in said pre-compacted state, said distal puncturing cannula tip overlies the non-punctured injection vial stopper and, in compacted state, said distal puncturing cannula tip punctures through the injection vial stopper for flow communication with the vial tube.

12. The device according to claim 11 wherein said safety catch mechanism is constituted by a twist release safety catch mechanism including:
said outer vial adapter body having a diametric pair of L-shaped tracks,
each said L-shaped track having a major track leg co-directional with said longitudinal vial adapter centerline, a minor track leg transverse to said longitudinal vial adapter centerline, a start track end adjacent said lowermost downward depending skirt rim and a finish track end adjacent said uppermost transverse outer vial adapter body wall,
each said minor track leg including a one-way passage arrangement for irreversibly priming said integral telescopic vial adapter in an intermediate primed state,
said inner vial adapter body having a diametric pair of radial outward projections for travelling along said diametric pair of L-shaped tracks from said start track end in said pre-compacted state to said finish track end in said compacted state,
said twist release safety catch mechanism requiring an initial manual rotation of said inner vial adapter body with respect to said outer vial adapter body about said longitudinal vial adapter centerline for priming said vial adapter from an initial pre-compacted state to said intermediate primed state for enabling said compaction of said vial adapter from said pre-compacted state to said compacted state.

13. The device according to claim 12 wherein each said finish track end includes a one-way passage arrangement for irreversibly clamping said vial adapter in said final compacted state.

14. The device according to claim 12 wherein said inner vial adapter body has a diametric pair of radial outward finger grips towards said lowermost downward depending vial crown sleeve rim and said outer vial adapter body has a diametric pair of anti-slip surfaces orthogonal to said diametric pair of radial outward finger grips in said initial pre-compacted state for assisting said manual rotation of said inner vial adapter body with respect to said outer vial adapter body.

15. The device according to claim 11 wherein said safety catch mechanism is constituted by a pull release safety catch mechanism requiring an initial manual extension of said inner vial adapter body with respect to said outer vial adapter body co-directional with said longitudinal vial adapter centerline to an intermediate primed state to release said safety catch mechanism for enabling said compaction of said vial adapter from said pre-compacted state to said compacted state.

16. The device according to claim 11 wherein said safety catch mechanism includes a safety catch transversely extending through said outer vial adapter body in said pre-compacted state thereby blocking said compaction of said integral telescopic vial adapter from said pre-compacted state to said compacted state whereby a manual withdrawal of said safety catch from said outer vial adapter body enables said compaction of said integral telescopic vial adapter from said pre-compacted state to said compacted state.

17. The device according to claim 11 for use with an intact discrete injection vial release tool with an opposite pair of inward directed protrusions for applying a pincers-like compression for releasing a non-punctured intact discrete injection vial from said integral telescopic vial adapter,
said vial crown sleeve including a major vial crown sleeve surround and a diametric pair of injection vial holding members pivotal with respect thereto such that each said vial crown holding member has a proximal vial crown holding member section and a distal vial crown holding member section,
each said distal vial crown holding member section having a radial inward vial crown holding projection towards said lowermost vial crown sleeve rim for snap fitting under the vial crown on telescopic snap fitting said inner vial adapter body on the initially non-punctured intact discrete injection vial,
said diametric pair of proximal vial crown holding member sections being pivotal with respect to said major vial crown sleeve surround such that application of the pincers-like compression on said diametric pair of proximal vial crown holding member sections distances said diametric pair of radial inward vial crown holding projections from said longitudinal vial adapter centerline for releasing the non-punctured intact discrete injection vial from said inner vial adapter body.

18. The device according to claim 17 wherein said downward depending skirt includes a diametric pair of through going discrete injection vial release apertures for providing access to the intact discrete injection vial release tool with the opposite pair of inward directed protrusions for applying the pincers-like compression in said pre-compacted state of said vial adapter.

19. The device according to claim 17 wherein said diametric pair of vial crown holding members pivot on said uppermost transverse annular inner vial adapter body wall on said application of the pincers-like compression.

20. The intact discrete injection vial release tool with the opposite pair of inward directed protrusions for use with the liquid transfer device according to claim 17 being configured as a pincers-like hand tool having an opposite pair of jaws with the opposite pair of inward directed protrusions.
